(19) United States
(12) Patent Application Publication
(10) Pub. No.: US 2019/0390089 A1
(43) Pub. Date: Dec. 26, 2019

(54) PROCESS FOR STRIPPING PROTECTIVE FILM OFF A FOAM TAPE

(71) Applicant: Jun JU, Taizhou City, Jiangsu Province (CN)

(72) Inventors: Jun JU, Taizhou City, Jiangsu Province (CN); Zhengyan JIANG, Taizhou City, Jiangsu Province (CN); Jinlong Ju, Taizhou City, Jiangsu Province (CN)

(21) Appl. No.: 16/481,330

(22) PCT Filed: Nov. 30, 2017
(86) PCT No.: PCT/CN2017/113844

§ 371 Date: Jul. 26, 2019

(30) Foreign Application Priority Data
Sep. 11, 2017 (CN) 201710811654.6

(51) Int. Cl. C09J 7/40; C09J 9/00

(52) U.S. Cl. CPC C09J 7/403; C09J 9/00

(57) ABSTRACT

The invention discloses a process for stripping a protective film off a foam tape, mainly comprising the step of providing a release film layer between a tape layer and a protective film layer, wherein a releasing force of the releasing film layer has a gram weight of 5 g, and the release film layer comprises a attached section bonded with the tape layer and an extension section extending beyond the tape layer, thereby reducing the releasing force between the protective film layer and the foam layer as well as the tape layer, so that release of the protective film layer is facilitated, and delamination of the foam layer is effectively avoided.

### TECHNICAL FIELD

The invention relates to the technical field of foam tapes, in particular to a process for stripping a protective film off a foam tape of a liquid crystal screen suitable for a vehicle-mounted backlight source.

### BACKGROUND ART

Foam tape is a material with the functions of shock absorption, sound absorption and sealing, which is prepared by taking a foam material as a base material in combination with a composite release material, and has a wide application to insulation, bonding, sealing, antiskid, buffering and shockproof for electronic and electrical products, mechanical parts, various small household appliances, mobile phone accessories, industrial instruments, computers and peripheral equipment, automobile accessories, video and audio equipment, toys, cosmetics, handicraft gifts, medical instruments, electric tools, office stationery, shelf display, home decoration, acrylic glass, ceramic products and the like. The conventional foam tape comprises a middle foam layer 101, tape layers 102 symmetrically adhered to two sides of the foam layer 101, and a protective film layer 103 connected to the tape layers 102; in the process of stripping the protective film layer 103 off the conventional foam tape, the foam layer 101 may be stretched, resulting in delamination of the foam layer 101.

### SUMMARY OF THE INVENTION

It's an object of the present invention to provide a process for stripping a protective film off a foam tape of a liquid crystal screen suitable for a vehicle-mounted backlight source, which solves the above-mentioned technical problem.

In order to achieve the technical object and meet the technical requirements, the technical solution adopted by the invention is as follows: a process for stripping a protective film off a foam tape, characterized by mainly comprising the step of providing a release film layer between a tape layer and a protective film layer, wherein a releasing force of the releasing film layer has a gram weight of 5 g.

As a preferred technical solution: the release film layer has a thickness of 0.075 mm.

The process for stripping the protective film of the foam tape, characterized in that: the process further comprises the steps of:

Step (1): firstly, attaching the tape layers to the front and back surfaces of the foam layer under the environment that the temperature is 23° C.-27° C. and the humidity is 55%-73%, and making sure that no foreign matters, wrinkles and breakage would occur in the attaching process;

Step (2): rolling by means of a roller after attaching the tape layers to the foam layer to ensure that the tape layers are completely attached to the foam layer;

Step (3): attaching the release film layer to the tape layer; wherein the release film layer comprises a attached section bonded with the tape layer and an extension section extending beyond the tape layer;

Step (4): attaching a protective film layer to the release film layer and the tape layer;

Step (5): forming in a stamping die; and

Step (6): putting in storage after formation.

As a preferred technical solution: the foam layer has a thickness of 0.3 mm.

As a preferred technical solution: the tape layer has a thickness of 0.1 mm.

As a preferred technical solution: the protective film layer has a thickness of 0.075 mm, and a releasing force thereof has a gram weight of 25 g.

As a preferred technical solution: the length A of the release film layer is 25±5 mm.

As a preferred technical solution: the length of the extension section is half of the length of the attached section.

As a preferred technical solution: the step (4) of, firstly, attaching the protective film layer to the release film layer, rolling by means of a roller to ensure that the protective film layer is completely attached to the release film layer, secondly, attaching the protective film layer to the tape layer, and rolling by means of a roller integrally to ensure that the protective film layer is completely attached to the release film layer and the tape layer. The present invention has the beneficial effects as follows: compared with the conventional process, according to the process for stripping a protective film off a foam tape of the present invention, a release film layer is provided between the tape layer and the protective film layer, wherein a releasing force of the releasing film layer has a gram weight of 5 g, the releasing force between the protective film layer and the foam layer as well as the tape layer is reduced, release of the protective film layer is facilitated, and delamination of the foam layer is effectively avoided.

### BRIEF DESCRIPTION OF THE DRAWINGS

FIG. 1 is a schematic diagram showing the structure of the present invention;

FIG. 2 is a schematic diagram of delamination of the foam layer of the present invention;

FIG. 3 is a schematic diagram of a structure in the prior art against the present invention;

Reference numerals in the drawings: 1. Release film layer, 1-1. attached section, 1-2. extension section.

### DETAILED DESCRIPTION OF THE INVENTION

The invention is further described hereinafter with reference to the accompanying drawings; In the drawings: the invention discloses a process for stripping a protective film off a foam tape, mainly comprising the following steps: a release film layer 1 is provided between the tape layer 102 and the protective film layer 103; the release film layer 1 has a thickness of 0.075 mm, and the releasing force of the release film layer 1 has a gram weight of 5 g; in practical use, by advantage of the action of the release film layer 1, the releasing force between the protective film layer 103 and the foam layer 101 as well as the tape layer 102 is reduced, release of the protective film layer 103 is facilitated, and delamination of the foam layer 101 shown at the circle 104 in FIG. 2 is effectively avoided.

The process further comprises the steps of:

Step (1): firstly, attaching the tape layers 102 to the front and back surfaces of the foam layer 101 under the environment that the temperature is 23° C.-27° C. and the humidity is 55%-73%, and making sure that no foreign matters, wrinkles and breakage would occur in the attaching process; wherein the foam layer 101 has a thickness of 0.3 mm and the tape layer 102 has a thickness of 0.1 mm;

Step (2): rolling by means of a roller after attaching the tape layers 102 to the foam layer 101 to ensure that the tape layers 102 are completely attached to the foam layer 101;

Step (3): attaching the release film layer 1 to the tape layer 102; wherein the release film layer 1 comprises a attached section 1-1 bonded with the tape layer 102 and an extension section 1-2 extending beyond the tape layer 102, thereby reducing the use of the release film layer 1, so that costs are reduced, and it can be ensured that the foam layer 101 does not delaminate;

Step (4): attaching a protective film layer 103 to the release film layer 1 and the tape layer 102; wherein the protective film layer 103 has a thickness of 0.075 mm, and the releasing force thereof has a gram weight of 25 g; firstly, attaching the protective film layer 103 to the release film layer 1, rolling by means of a roller to ensure that the protective film layer 103 is completely attached to the release film layer 1, secondly, attaching the protective film layer 103 to the tape layer 102, and rolling by means of a roller integrally to ensure that the protective film layer 103 is completely attached to the release film layer 1 and the tape layer 102;

Step (5): forming in a stamping die; and

Step (6): putting in storage after formation.

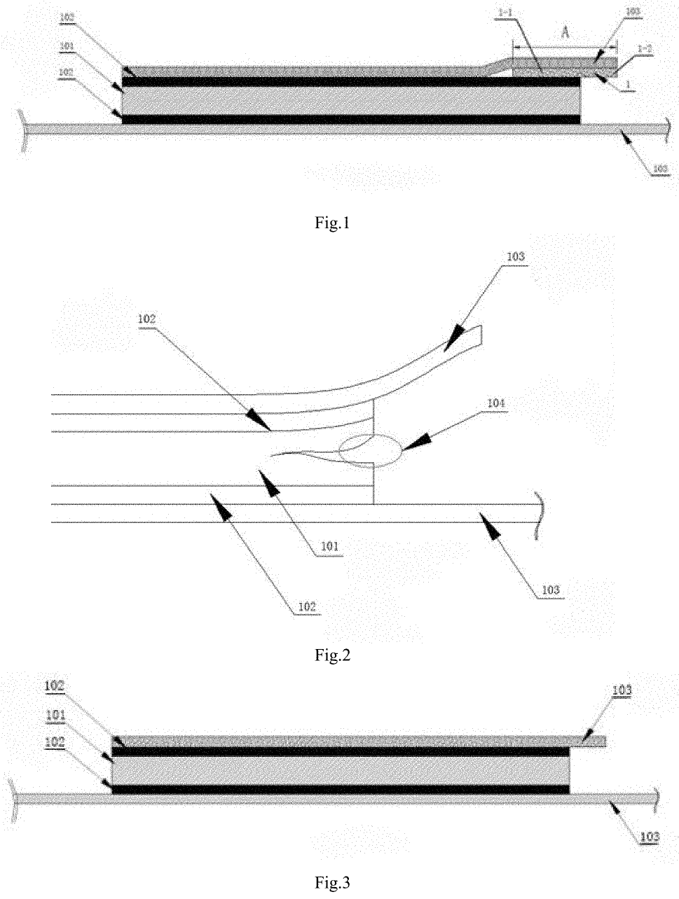

In FIG. 1: the length A of the release film layer 1 is 25±5 mm; the length of the extension section 1-2 is half of the length of the attached section 1-1; the use of the release film layer 1 is reduced, so that costs are reduced, and it can be ensured that the foam layer 101 does not delaminate.

The above-described embodiments are merely illustrative of the present invention and are not intended to limit the embodiments; various other changes or modifications made by persons skilled in the art are allowed, and the listed embodiments are not exhaustive. Those obvious changes or modifications generated therefrom still fall within the scope of this invention.

1. A process for stripping a protective film off a foam tape, characterized by mainly comprising the step of providing a release film layer (1) between a tape layer (102) and a protective film layer (103), wherein a releasing force of the releasing film layer (1) has a gram weight of 5 g.

2. The process for stripping the protective film of the foam tape according to claim 1, characterized in that: the release film layer (1) has a thickness of 0.075 mm.

3. The process for stripping the protective film of the foam tape according to claim 1, characterized in that: the process further comprises the steps of:
Step (1): firstly, attaching the tape layers (102) to the front and back surfaces of the foam layer (101) under the environment that the temperature is 23° C.-27° C. and the humidity is 55%-73%, and making sure that no foreign matters, wrinkles and breakage would occur in the attaching process;
Step (2): rolling by means of a roller after attaching the tape layers (102) to the foam layer (101) to ensure that the tape layers (102) are completely attached to the foam layer (101);
Step (3): attaching the release film layer (1) to the tape layer (102); wherein the release film layer (1) comprises a attached section (1-1) bonded with the tape layer (102) and an extension section (1-2) extending beyond the tape layer (102);
Step (4): attaching a protective film layer (103) to the release film layer (1) and the tape layer (102);
Step (5): forming in a stamping die; and
Step (6): putting in storage after formation.

4. The process for stripping the protective film of the foam tape according to claim 3, characterized in that: the foam layer (101) has a thickness of 0.3 mm.

5. The process for stripping the protective film of the foam tape according to claim 3, characterized in that: the tape layer (102) has a thickness of 0.1 mm.

6. The process for stripping the protective film of the foam tape according to claim 3, characterized in that: the protective film layer (103) has a thickness of 0.075 mm, and a releasing force thereof has a gram weight of 25 g.

7. The process for stripping the protective film of the foam tape according to claim 3, characterized in that: the length A of the release film layer (1) is 25±5 mm.

8. The process for stripping the protective film of the foam tape according to claim 3, characterized in that: the length of the extension section (1-2) is half of the length of the attached section (1-1).

9. The process for stripping the protective film of the foam tape according to claim 3, characterized in the step (4) of, firstly, attaching the protective film layer (103) to the release film layer (1), rolling by means of a roller to ensure that the protective film layer (103) is completely attached to the release film layer (1), secondly, attaching the protective film layer (103) to the tape layer (102), and rolling by means of a roller integrally to ensure that the protective film layer (103) is completely attached to the release film layer (1) and the tape layer (102).
